(19) United States
(12) Patent Application Publication
(10) Pub. No.: US 2004/0092279 A1
(43) Pub. Date: May 13, 2004

(54) Automatic data distributing system and method

(75) Inventor: Ken Yoshikawa, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 10/699,073

(22) Filed: Oct. 30, 2003

(30) Foreign Application Priority Data
Oct. 30, 2002 (JP) 2002-316637

(51) Int. Cl. H04Q 7/20; H04B 7/00; H04B 1/38

(52) U.S. Cl. 455/514; 455/560; 455/445; 455/412.1

(57) ABSTRACT

An automatically data delivering system including a server and a mobile communication device is disclosed. The server stores a plurality of pieces of data, from which a piece of data is selected in response to a data request received from the mobile communication device. The selected piece of data is transmitted back to the mobile communication device. The mobile communication device transmits the data request to the server depending on a user-designated time condition. When the selected piece of data is downloaded from the server, the downloaded piece of data is stored in the memory and is reproduced by a display and a speaker.

### BACKGROUND OF THE INVENTION

1. Field of the Invention

The present invention relates to a data distribution system including servers and mobile communication terminals and in particular to a system and method for automatically distributing a content from a server to a mobile communication terminal such as a mobile telephone terminal or a personal information terminal.

2. Description of the Related Art

There have been commercially available various types of mobile communication devices employing Java® technology (J2ME/CLDC: Java2 Platform, Micro Edition/Connected, Limited Device Configuration), allowing Java programs to run on a Java virtual machine (JVM) implemented therein. As image/sound compression technology progresses, almost telecommunications carriers can handle still and moving images with the high quality of sound. Accordingly, today, with new contents daily released from software companies, new applications can be always downloaded to Java-enable mobile communication devices such as mobile telephone devices or mobile information terminals.

In such a situation, several methods of downloading contents to mobile terminals have been proposed. For example, Japanese Patent Application Unexamined Publication No. 2001-282672 discloses an automatic information delivery system in which a mobile terminal sends a request for content to a server and thereby obtains the content from the server. Japanese Patent Application Unexamined Publication No. 2002-176516 discloses a method of providing a content for standby image to a mobile terminal, in which the mobile terminal visits a home page on the Internet to select a desired one of standby images provided on the home page and downloads it from the home page. Japanese Patent Application Unexamined Publication No. 2002-218060 discloses a system of easily registering a standby image for a mobile terminal, in which a user creates an image file and register it to a home page and then the image can be downloaded as a standby image to a mobile terminal.

However, when a user wishes to install a new standby image on the user's mobile telephone device, the user must perform a sequence of operations: connect to the Internet, search for a desired image on the connected homepage, download the desired image, and install it to the mobile telephone device. For almost all users, such a sequence of installation operations is burdensome, especially for users to frequently change its standby image on the mobile telephone device or to use the predetermined kind of image as a standby image on the mobile telephone device.

### SUMMARY OF THE INVENTION

An object of the present invention is to provide a system and method for automatically delivering data from a server to a mobile communication terminal.

Another object of the present invention is to provide a mobile communication terminal for automatically downloading data from a server without any inconvenience.

According to the present invention, a server includes a data memory for storing a plurality of pieces of data; and a server controller controlling such that a piece of data is selected from the data memory in response to a data request received from the mobile communication device and a selected piece of data is transmitted back to the mobile communication device. A mobile communication device includes an output device; a memory; a data request controller for controlling transmission of the data request to the server depending on a user-designated time condition; and a controller controlling such that the selected piece of data downloaded from the server is stored in the memory, wherein the selected piece of data is reproduced by the output device.

Each piece of data stored in the data memory may include image data and sound data. The output device preferably an image displaying section (a display such as LCD) and a sound outputting section such as a speaker. The controller preferably controls such that the image data of the selected piece of data is displayed on the image displaying section and the sound data of the selected piece of data is reproduced by the sound outputting section.

As one example, the user-designated time condition is at least one date and time, at which the data request controller transmits the data request to the server. As another example, the user-designated time condition is a time period, wherein the data request controller transmits the data request to the server at intervals of the time period.

Preferably, the data request controller holds the transmission of a data request to the server when at least one function is operating in the mobile communication device.

The controller may control such that the selected piece of data is reproduced by the output device immediately after the selected piece of data has been downloaded from the server, allowing an enhanced alarm system.

At the server, a piece of data may be selected randomly from the data memory. Alternatively, a piece of data may be selected depending on a predetermined sequence

According to another aspect of the present invention, a method for delivering data from a server to a mobile communication device through a network, includes the following steps: at the mobile communication device, determining a transmission condition of a data request depending on a user's instruction; and transmitting the data request to the server when the transmission condition is met, at the server, storing a plurality of pieces of data; receiving the data request from the mobile communication device; selecting a piece of data from the data memory in response to the data request; transmitting a selected piece of data to the mobile communication device, and at the mobile communication device, storing the selected piece of data downloaded from the server in a memory; and reproducing the selected piece of data.

The server may store Java applications and the transmission condition of a data request is determined by: downloading a Java application from the server; and setting the transmission condition in the Java application. The Java application is executed in the mobile communication device to download a necessary piece of data from the server.

As described above, since the selected piece of data downloaded from the server is stored in the memory, the selected piece of data can be reproduced at the mobile communication device at all times. More specifically, the received image can be displayed on the display at all times. Accordingly, the downloaded image can be used as a standby image on the display. In addition, since the image and sound data are automatically downloaded each time the designated transmission time condition is met, the standby image on the display can be automatically changed without any user's operations.

Further, each time the selected piece of data are downloaded from the server, which may be different from the previously downloaded data, the image is displayed and the sound is reproduced. Therefore, the above-described data downloading operation may also serve as an alarm operation, which is issued at a designated time or at designated intervals depending on the designated time information.

### BRIEF DESCRIPTION OF THE DRAWINGS

FIG. 1 is a schematic diagram showing an automatic data delivery system according to an embodiment of the present invention;

FIG. 2 is a block diagram showing a mobile communication device in the automatic data delivery system according to the embodiment of the present invention;

FIG. 3 is a diagram showing a server in the automatic data delivery system according to the embodiment of the present invention;

FIG. 4 is a flow chart showing a first example of a data downloading operation of the mobile communication device;

FIG. 5 is a sequence diagram showing the first example of the data downloading operation of the mobile communication device;

FIG. 6 is a flow chart showing a second example of a data downloading operation of the mobile communication device; and

FIG. 7 is a schematic diagram showing an automatic data delivery system according to another embodiment of the present invention.

### DESCRIPTION OF THE PREFERRED EMBODIMENTS

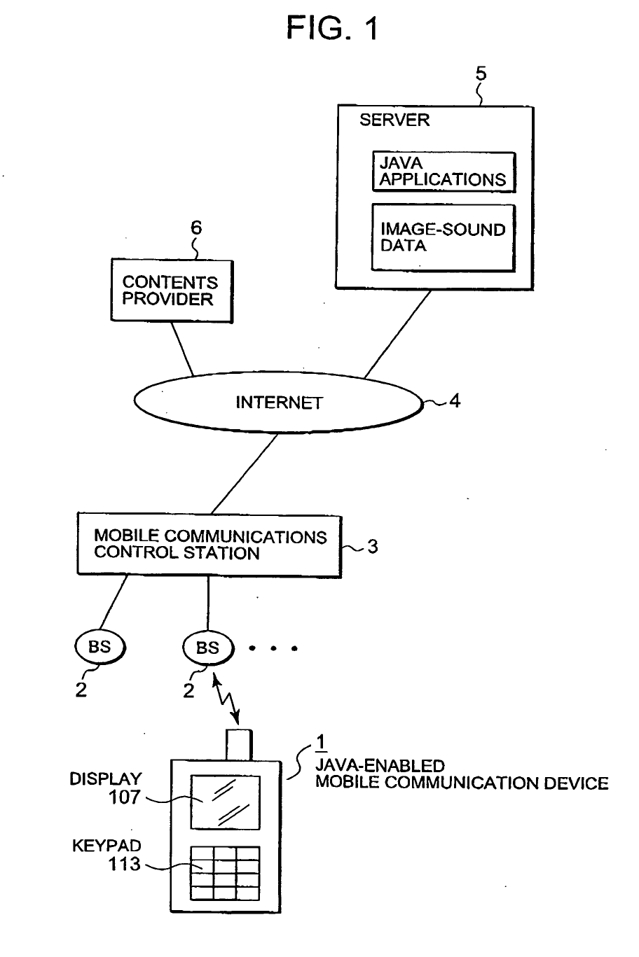

As shown in FIG. 1, it is assumed for simplicity that an automatic data delivery system according to a first embodiment of the present invention includes a mobile communication device 1, a plurality of base stations 2, a mobile communications control station 3, the Internet 4, a content server 5, and a content provider 6.

The mobile communication device 1 has a Java platform implemented therein, allowing Java applications to be executed thereon. The mobile communication device 1 can communicate with the server 5 through a nearest base station 2, the mobile communications control station 3 and the Internet 4.

The server 5 stores Java applications and a plurality of pieces of resource data, which are used in a Java application. An image-sound memory contains the resource data composed of a plurality of pieces of image data and a plurality of pieces of sound data. Each image data piece may be a still image or a moving image. The image and sound data pieces can be retrieved in response to a user's request. The Java applications and the image/sound data pieces are installed and updated by the content provider 6.

As described later, a data request is automatically sent from the mobile communication device 1 to the server 5 depending on user-designated time information, for example, at a user-designated date and time or at intervals of a user-designated time period. When having received such a request from the mobile communication device 1, the server 5 selects a pair of image and sound data pieces from the image-sound memory randomly or depending on a predetermined rule. Thereafter, the server 5 transmits the selected pair of image and sound data pieces back to the mobile communication device 1. The detailed structures and operations of the first embodiment will be described hereinafter, taking a mobile telephone device as an example.

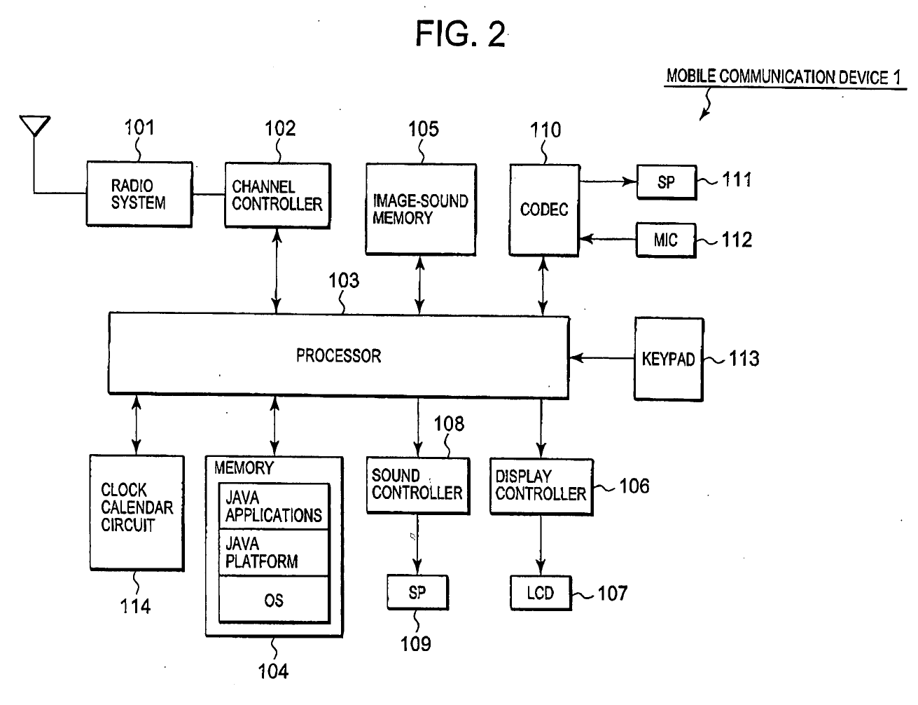

Referring to FIG. 2, the mobile communication device 1 has a radio communication section composed of a radio system 101 and a channel controller 102, which are controlled by a program-controlled processor 103. The radio system 101 performs well-known operations including radio-frequency amplification, frequency conversion between radio frequency and intermediate frequency, modulation or demodulation, compression or decompression, and analog-to-digital or digital-to-analog conversion.

The program-controlled processor 103 may be a central processing unit (CPU), which can executes an operating system (OS), a Java platform including a JVM, configuration and profile, and Java applications. The operating system and the Java platform are previously stored in a memory 104 and their installation has been completed. The memory 104 may be a volatile memory or a non-volatile memory. Any Java application can run on the Java platform.

The Java applications are downloaded from the server through radio communication and are installed. The user can use the above-described Java environment to set each Java application for permission or inhibition of network connection. Therefore, the network connection request invoked by an installed Java application is set to valid or invalid depending on the previous setting.

A Java application, which will be described later, runs on the processor 103 and, as necessary, downloads image and sound data pieces from the server 5. The downloaded image and sound data may be stored into an image-sound memory 105. The downloaded image data is displayed on a display device 107 such as LCD (liquid-crystal display device) through a display controller 106. The downloaded sound data is reproduced by a sound outputting device (speaker) 109 through a sound controller 108.

As known well, telephone conversation may be performed by using a speech codec 110, a speaker (telephone receiver) 111 and a microphone (telephone transmitter) 112. The user can use a keypad 113 including ten-key pad to enter phone numbers for dialing or instructions for the above-described network connection setting and user-designated time information setting. Further, the processor 103 uses a clock/calendar circuit 114 or a timer (not shown) and the user-designated time information to determine whether to transmit a content transmission request to the server 5, which will be described later.

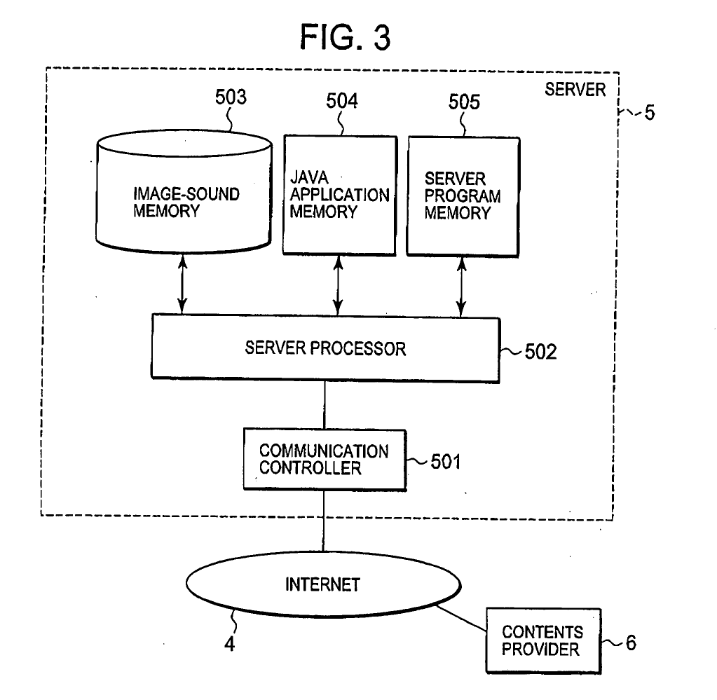

Referring to FIG. 3, the server 5 is provided with a communication controller 501, which allows communications through the Internet 4. The server 5 is further provided with a server processor 502, which is a program-controlled processor 502 such as a CPU. The server processor 502 controls an image-sound memory 503 and a Java application memory 504 by executing a server program stored in a server program memory 505.

The image-sound memory 503 stores resource data, which are used in each of Java applications. The resource data composed of a plurality of pieces of image data and a plurality of pieces of sound data, which are retrieved depending on a user's request. The Java application memory 504 stores a plurality of Java applications, which may be downloaded to a mobile communication device 1 depending on a user's request. The Java applications and the image/sound data pieces are installed and updated by the content provider 6.

As described later, in response to the user's data request, the server program running on the server processor 502 selects a pair of image and sound data pieces from the image-sound memory 503 randomly or depending on a predetermined sequence Thereafter, the server program running on the server processor 502 instructs the communication controller 501 to transmit the selected pair of image and sound data pieces back to the mobile communication device 1.

### Operation

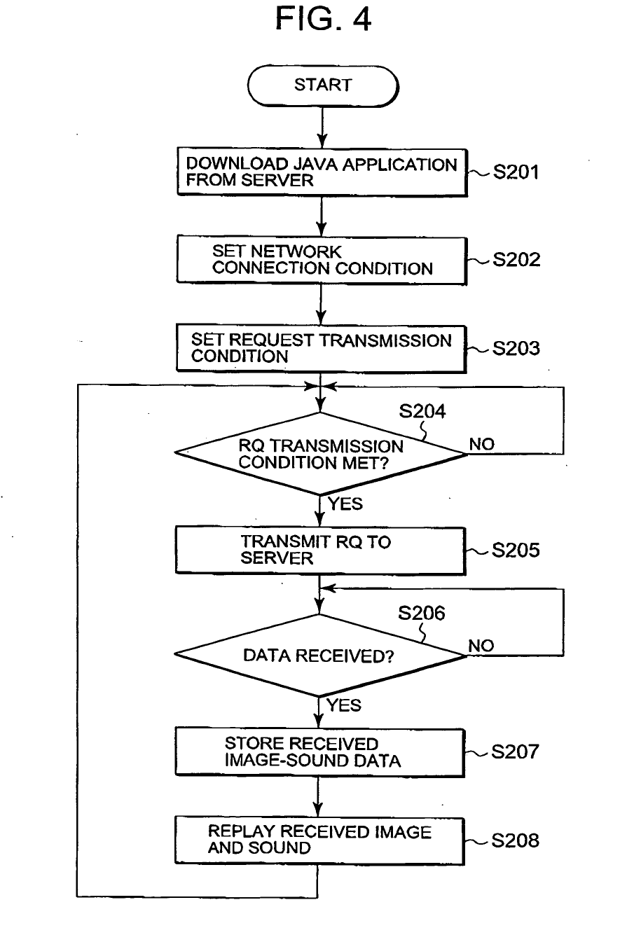

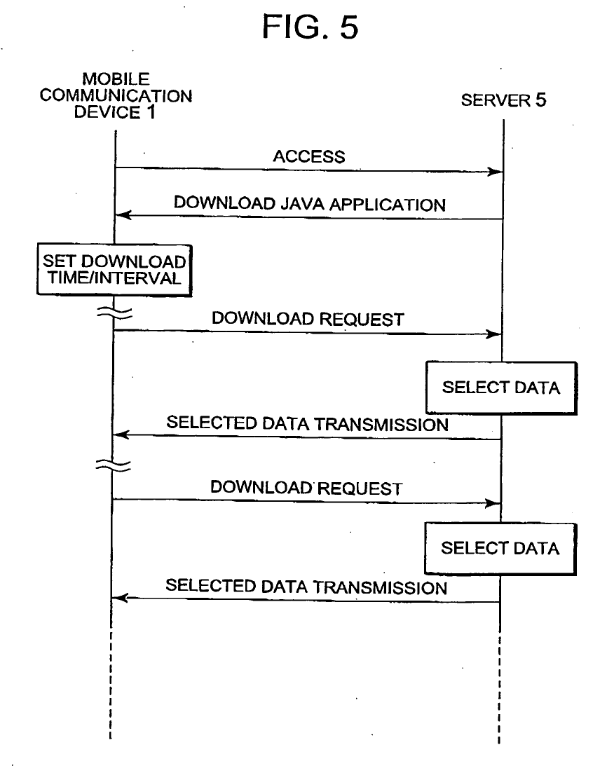

Referring to FIG. 4 and FIG. 5, the user operates the keypad 113 to access the Web page on the server 5 through the radio communication section and download a Java application from the server 5 (step S201). The downloaded Java application is stored in the memory 104. Thereafter, the user operates the keypad 113 to set the network connection condition indicating permission or inhibition of network connection for each Java application (step S202).

Further, in standby status, the user operates the keypad 113 to start the Java application and set the time information to determine when to transmit a content transmission request to the server 5 (step S203). More specifically, the user enters at least one date and time when the data request is to be transmitted to the server S as the time information. Alternatively, the user may enter a time period as the time information so that the data request is transmitted to the server 5 at intervals of the designated time period.

When the necessary conditions have been completely set in the Java application as described above, the processor 103 determines whether to meet the designated request transmission condition (step S204). More specifically, in the case of the date and time designated as the designated request transmission condition, it is determined whether the current time reaches the designated date and time. In the case of the time period designated as the designated request transmission condition, it is determined whether the designated time period has elapsed.

When the designated request transmission condition is met (YES in step S204), the processor 103 creates a content transmission request and instructs the radio communication section to transmit it to the server 5 (step S205) and waits for a response to the request (step S206).

At the server 5, as shown in FIG. 5, the server processor 502 selects a pair of image and sound data pieces from the image-sound memory 503 randomly or depending on a predetermined sequence. The selected pair of image and sound data pieces are transmitted back to the mobile communication device 1.

Returning to FIG. 4, when having received the selected pair of image and sound data pieces from the server 5 (YES in step S206), the processor 103 stores the received image and sound data pieces into the image-sound memory 105 (step S207). Thereafter, the processor 103 instructs the display controller 106 and the sound controller 108 to display the received image on the LCD 107 and reproduce the received sound through the speaker 109 (step S208). As shown in FIG. 5, the steps S204-S208 are repeatedly performed each time the designated request transmission condition is met (YES in step S204).

In this manner, since the received image and sound data pieces are stored in the image-sound memory 105, the received image can be displayed on the LCD 107 at all times. Accordingly, the received image can be used as a standby image on the LCD 107. In addition, since the image and sound data pieces are automatically downloaded each time the designated request transmission condition is met, the standby image on the LCD can be automatically changed without any user's operations.

Further, each time the image and sound data pieces are received from the server 5, which may be different from the previously received data pieces, the image is displayed and the sound is reproduced. Therefore, the above-described content downloading operation may also serve as an alarm, which is issued at a designated time or at designated intervals depending on the designated time information.

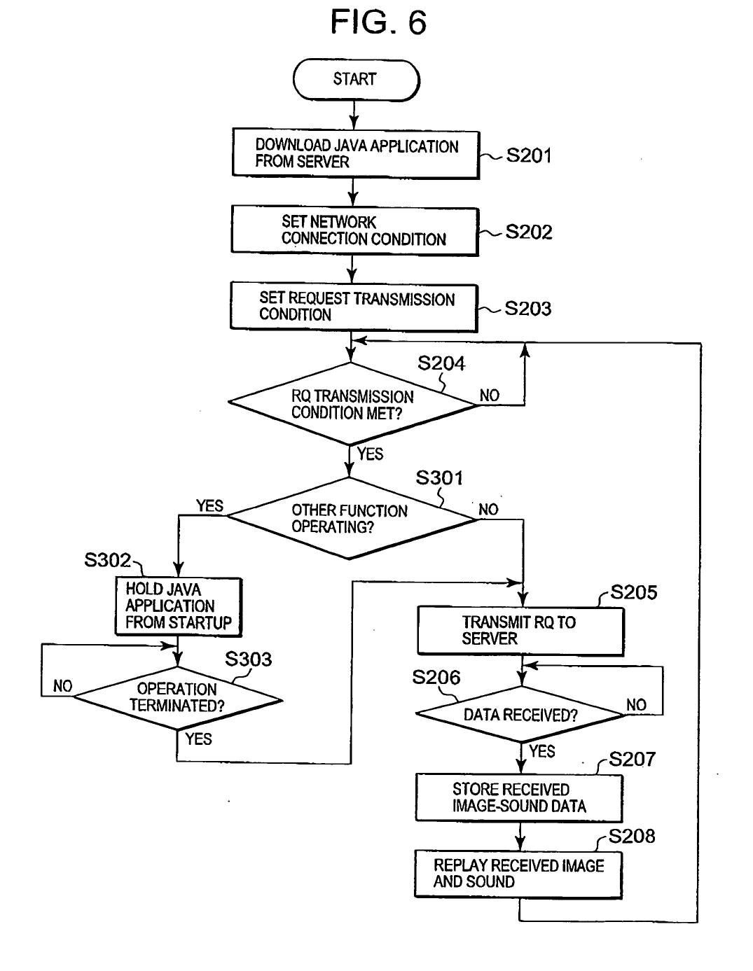

Another example of the data downloading operation will be described with reference to FIG. 6. In FIG. 6, steps similar to those previously described with reference to FIG. 4 are denoted by the same reference symbols (S201-S204 and S205-S208) and the descriptions are omitted.

According to the present example, as shown in FIG. 6, when the designated request transmission condition is met (YES in step S204), the processor 103 further determines whether at least one other function is operating (step S301). When the other function is operating (YES in step S301), the processor 103 holds the startup of the Java application (step S302) and determines whether the other operation is terminated (step S303) When the other operation has been terminated and no function is operating (YES in step S303), the processor 103 starts the Java application to create a content transmission request and instructs the radio communication section to transmit it to the server 5 (step S205) Thereafter, the steps S205-S208 are performed as described before.

When the other operation has been terminated (YES in step S303), the processor 103 may instruct the display controller 106 to display a prompt image so as to inform a user of operation interrupt. In this case, when the user enters data transmission request, control goes to the step S205.

According to the present example as shown in FIG. 6, even when other functions are operating at the time of the data downloading operation, the data downloading operation can be performed surely after the other function has been terminated. For example, in the case where the server 5 updates the contents of the image-sound database 503 once a month, the user can set the mobile communication device 1 such that the data request is transmitted to the server 5 in synchronization with the update timing of the server 5. In such a case, if the steps S301-S303 are not implemented, the user may fail to download the updated image and sound data. According to the present example as shown in FIG. 6, the user can surely download the updated image and sound data.

According to a second embodiment of the present invention, image and sound data pieces can be downloaded from a plurality of servers. In this case, it is necessary for the Java application to previously have the address of each server.

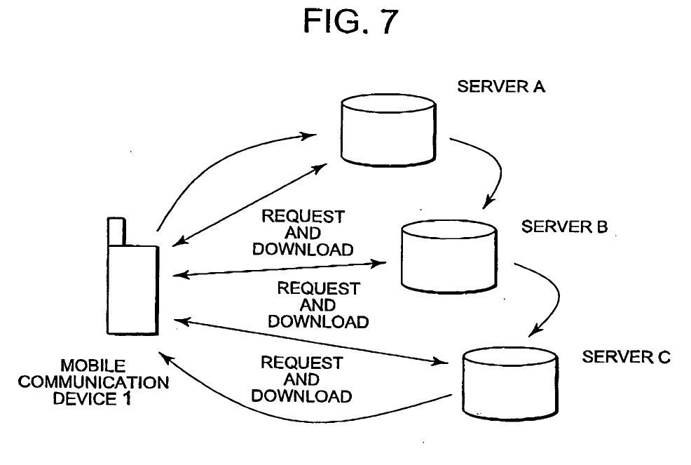

As shown in FIG. 7, when such a Java application starts up, a data request is sequentially sent to the servers A, B and C to download image and sound data pieces from each of the servers. If an incoming call occurs during the data downloading operation, then the data downloading operation temporarily stops and stores the addresses of servers from which image and sound data pieces has been downloaded. After the call has been terminated, the processor 103 restarts the Java application to sequentially access the remaining servers. After the necessary image and sound data pieces have been downloaded from all the designated servers, the data downloading operation is terminated.

When the data downloading operation temporarily stops, the processor 103 may instruct the display controller 106 to display a prompt image so as to inform a user of operation interrupt. In this case, when the user enters a restart instruction of the data downloading operation, the data downloading operation is restarted.

1. A system for delivering data from a server to a mobile communication device through a network, wherein
the server comprises:
a data memory for storing a plurality of pieces of data; and
a server controller controlling such that a piece of data is selected from the data memory in response to a data request received from the mobile communication device and a selected piece of data is transmitted back to the mobile communication device, and
the mobile communication device comprises:
an output device;
a memory;
a data request controller for controlling transmission of the data request to the server depending on a user-designated time condition; and
a controller controlling such that the selected piece of data downloaded from the server is stored in the memory, wherein the selected piece of data is reproduced by the output device.

2. The system according to claim 1, wherein each piece of data stored in the data memory includes image data and sound data, wherein
the output device comprises an image displaying section and a sound outputting section; and
the controller controls such that the image data of the selected piece of data is displayed on the image displaying section and the sound data of the selected piece of data is reproduced by the sound outputting section.

3. The system according to claim 1, wherein the user-designated time condition is at least one date and time, at which the data request controller transmits the data request to the server.

4. The system according to claim 1, wherein the user-designated time condition is a time period, wherein the data request controller transmits the data request to the server at intervals of the time period.

5. The system according to claim 1, wherein the data request controller holds the transmission of a data request to the server when at least one function is operating in the mobile communication device.

6. The system according to claim 1, wherein the controller controls such that the selected piece of data is reproduced by the output device immediately after the selected piece of data has been downloaded from the server.

7. The system according to claim 1, wherein the server controller randomly selects a piece of data from the data memory.

8. The system according to claim 1, wherein the server controller selects a piece of data from the data memory depending on a predetermined sequence.

9. The system according to claim 1, wherein the data request controller is implemented by executing a Java application using the selected piece of data, wherein the Java application is downloaded from the server.

10. A method for delivering data from a server to a mobile communication device through a network, comprising:
at the mobile communication device,
determining a transmission condition of a data request depending on a user's instruction;
transmitting the data request to the server when the transmission condition is met;
at the server,
storing a plurality of pieces of data;
receiving the data request from the mobile communication device;
selecting a piece of data from the data memory in response to the data request;
transmitting a selected piece of data to the mobile communication device;
at the mobile communication device,
storing the selected piece of data downloaded from the server in a memory; and
reproducing the selected piece of data.

11. The method according to claim 10, wherein the server stores Java applications, wherein the transmission condition of a data request is determined by:
downloading a Java application from the server; and
setting the transmission condition in the Java application,
wherein the Java application is executed in the mobile communication device to download a necessary piece of data from the server.

12. The method according to claim 10, wherein the transmission condition of a data request is at least one date and time, at which the data request is transmitted to the server.

13. The method according to claim 10, wherein the transmission condition of a data request is a time period, wherein the data request is transmitted to the server at intervals of the time period.

14. The method according to claim 10, further comprising:
at the mobile communication device,
determining whether at least one function is operating in the mobile communication device;
when at least one function is operating, holding the transmission of a data request to the server until no function is operating.

15. The method according to claim 10, wherein each piece of data includes image data and sound data, wherein the image data of the selected piece of data is displayed on a display and the sound data of the selected piece of data is reproduced by a speaker immediately after the selected piece of data has been downloaded from the server.

16. The method according to claim 10, wherein at the server, the piece of data is randomly selected from the data memory.

17. The method according to claim 10, wherein at the server, the piece of data is selected from the data memory depending on a predetermined sequence.

18. A mobile communication device connected to a server through a network, comprises:
an output device;
a memory;
a data request controller for controlling transmission of a data request to the server depending on a user-designated time condition; and
a controller controlling such that a piece of data downloaded from the server is stored in the memory, wherein the piece of data is reproduced by the output device.

19. The mobile communication device according to claim 18, wherein the piece of data includes image data and sound data, wherein the output device comprises an image displaying section and a sound outputting section,
wherein the controller controls such that the image data of the selected piece of data is displayed on the image displaying section and the sound data of the selected piece of data is reproduced by the sound outputting section.

20. A server for delivering data to a mobile communication device through a network, comprising:
a data memory for storing a plurality of pieces of data; and
a server controller controlling such that a piece of data is selected from the data memory in response to a data request received from the mobile communication device and a selected piece of data is transmitted back to the mobile communication device.

21. A computer program instructing a computer to download data from a server to a mobile communication device through a network, comprising:
determining a transmission condition of a data request depending on a user's instruction;
transmitting the data request to the server when the transmission condition is met;
receiving a piece of data as a response to the data request from the server;
storing the piece of data in a memory; and
reproducing the selected piece of data.

22. A computer program instructing a computer to deliver data to a mobile communication device through a network, comprising:
storing a plurality of pieces of data;
receiving a data request from the mobile communication device;
selecting a piece of data from the data memory in response to the data request;
transmitting a selected piece of data to the mobile communication device.
